(19) United States
(12) Patent Application Publication
(10) Pub. No.: US 2026/0008310 A1
(43) Pub. Date: Jan. 8, 2026

(54) CONTROL ARM FOR A WHEEL SUSPENSION IN A MOTOR VEHICLE

(71) Applicant: BENTELER AUTOMOBILTECHNIK GMBH, Paderborn (DE)

(72) Inventors: Juergen HUMMELT, Paderborn (DE); Stephan MEYER, Bielefeld (DE)

(21) Appl. No.: 19/257,470

(22) Filed: Jul. 2, 2025

(30) Foreign Application Priority Data
Jul. 3, 2024 (EP) 24186262.2

(51) Int. Cl. B60G 7/00

(52) U.S. Cl. CPC B60G 7/001; B60G 2206/7102; B60G 2206/72; B60G 2206/82092

(57) ABSTRACT

A control arm for a wheel suspension in a motor vehicle. The control arm has a control arm body made of light metal, which has two side walls, and in at least one side wall an elongated hole is provided, which is designed and intended to cooperate with an eccentric adjustment device. At least one wall section of an inner wall of the elongated hole is formed by a reinforcing element, wherein the reinforcing element includes a material which has a higher hardness than the material of the side wall of the control arm body.

### RELATED APPLICATIONS

The present application claims priority of European Application Number 24186262.2 filed Jul. 3, 2024, the disclosure of which is hereby incorporated by reference herein in its entirety.

### FIELD

The present disclosure relates to a control arm for a wheel suspension in a motor vehicle with a control arm body made of light metal, for example, aluminum, which has two side walls, wherein an elongated hole is provided in at least one side wall, which hole is designed and intended to cooperate with an eccentric adjustment device.

### BACKGROUND

Control arms are components of the wheel suspension of a motor vehicle. The control arms absorb high forces, for example, braking and driving forces. In addition, control arms support the weight of a motor vehicle in cooperation with other chassis components.

A control arm is able to be aligned relative to the connection on the wheel carrier side via an eccentric adjustment device, which includes eccentric elements such as eccentric disks and eccentric screws and/or control elements. In this way, vehicle tolerances are able to be compensated and the track and/or camber of the wheels of a motor vehicle are able to be adjusted. The eccentric adjustment device interacts with elongated holes in the side walls of the control arm.

The following references include embodiments of control arms with eccentric adjustment devices as described in DE 10 2017 200 675 A1, DE 10 2019 002 874 A1 or EP 4 360 919 A1.

In order to achieve the lowest possible component weight, the control arm bodies are made of light metal or a light metal alloy, for example, from aluminum of the 5000 series to the 7000 series.

Control arm bodies made of light metal are advantageous in terms of weight. However, the components are also susceptible to damage and wear due to the high forces and moments acting during operation. The control arm bodies are also able to be damaged during assembly or during adjustment of the toe and camber angles. When adjusting the camber under load with the vehicle standing on its wheels during adjustment, the bolt or screw of the eccentric adjustment device is able to rub or dig into the elongated hole and the adjacent regions of the side wall of the control arm body, which is able to result in deformation and damage.

DE 10 2013 015 184 A1 describes a fiber-reinforced stiffening strut with an elongated hole in which a bushing is arranged.

EP 4 378 718 A1 describes a generic control arm for a wheel suspension in a motor vehicle.

U.S. Pat. No. 11,421,723 B2 describes a reinforcement structure for a through-opening arranged in an aluminum component.

The object of the present disclosure is a functionally improved control arm with a higher level of wear protection in the region of the connection of an eccentric adjustment device on or in the side walls of the control arm body.

This object is achieved by a control arm.

Embodiments and modifications of features of the control arm according to the present disclosure which, individually or in combination, design and/or refine the present disclosure in a technically advantageous manner are also able to be found in the description and the accompanying drawings.

A control arm according to the present disclosure for a wheel suspension in a motor vehicle has a control arm body. The control arm body is made of light metal, for example, aluminum or an aluminum alloy from the 5000 series to the 7000 series.

The control arm body is also able to be made of fiber-reinforced plastic (FRP). Fiber-reinforced plastics are used here with high specific stiffness and strength, which are on the level of aluminum alloys or high-strength steels.

The control arm body has two side walls, which are parallel to each other. An elongated hole is provided in at least one side wall. The elongated hole is configured and intended to cooperate with an eccentric adjustment device. The eccentric adjustment device is able to be used to determine the relative position of the control arm to the wheel suspension and to adjust the camber angle. The track is adjusted passively via the camber angle.

The control arm body is able to be a cast, forged or extruded part.

According to the present disclosure, at least one wall section of an inner wall of the at least one elongated hole is formed by a reinforcing element, wherein the reinforcing element includes a material which has a higher hardness than the material of the side wall of the control arm body.

Eccentric stops are arranged to the left and right of the elongated hole. The reinforcing element or the material from which the reinforcing element is formed also has a higher hardness than the eccentric stops; for example, the eccentric stops are formed from a single piece of material in or from a side wall of the control arm body.

The reinforcing element is designed as an insert in the side wall of the control arm body and is arranged locally in the loaded region of the connection between the eccentric adjustment device and the control arm body. The local arrangement of the reinforcing element reduces weight and material, thus saving resources.

The reinforcing element is harder and stronger than the material of the control arm body or the side wall of the control arm body. The reinforcing element creates a wall section in the elongated hole in a targeted and local manner, which offers a significantly higher mechanical resistance to the mechanical penetration of the bolt of the eccentric adjustment device than the material of the side wall of the control arm body.

A reinforcing element reinforces the elongated hole at least on one side. Multiple reinforcing elements are also able to be provided, for example, two reinforcing elements on opposite wall sections of the inner wall of the elongated hole. In at least one embodiment of the present disclosure, the reinforcing element is provided on or in the upper longitudinal side of the elongated hole, and a reinforcing element is able to be arranged on the upper longitudinal side and/or on the lower longitudinal side and/or on one or both narrow sides of the elongated hole.

In connection with hardness, Rockwell is an internationally used unit of measurement for the hardness of a material. The hardness is also able to be determined according to Vickers or the Vickers hardness test.

The material of the reinforcing element also has a higher strength than the material of the control arm body or the side wall of the control arm body. The reinforcing element also has a higher resistance to deformation than the adjacent region of the side wall of the control arm body.

The reinforcing element is made of steel or a steel alloy.

The reinforcing element is made of a material that has a hardness that is harder or as hard as the bolt or a screw of the eccentric adjustment device, which is guided through the elongated hole in the side wall and rests against the reinforced wall section or the reinforcing element.

The control arm body is made of aluminum or an aluminum alloy. Accordingly, the two side walls of the control arm body are made of aluminum or an aluminum alloy.

The control arm body is able to be an extruded profile or be formed from an extruded profile.

The control arm body is also able to be a forged or cast component.

In at least one embodiment of the present disclosure, the reinforcing element is arranged in a recess in the side wall of the control arm body adjacent to the elongated hole. The recess has a width corresponding to the wall thickness of the side wall of the control arm body. The reinforcing element therefore has a width that is equal to or substantially equal to the wall thickness of the side wall.

An elongated hole has a length that corresponds to the diameter of an eccentric bolt that passes through the elongated hole plus the required or specified adjustment travel for adjusting the camber.

A side wall of the control arm body has a wall thickness of 3 mm to 10 mm, or 3.5 mm to 9 mm.

The recess for the reinforcing element or the insert forming the reinforcing element is produced when punching the elongated hole in the side wall. Accordingly, no further work step is necessary.

The recess is open towards the elongated hole.

The reinforcing element is inserted into the recess and forms a wall section of the inner wall of the elongated hole.

In at least one embodiment of the present disclosure, the reinforcing element is pressed and press-fitted into the recess in the side wall of the control arm body. The joint is highly stable and resilient. Forces are reliably absorbed and transmitted. The control arm body, which is made of light metal, and its side wall are protected from wear and damage by the reinforcing element in the connection region between the eccentric adjustment device and the control arm body, for example, in the region in which the eccentric bolt or the eccentric screw of the eccentric adjustment device is supported.

Furthermore, the reinforcing element is able to have form-fitting surfaces which interact with contact surfaces of the recess. The contact surfaces are configured congruently to the form-fitting surfaces. Form-fitting surfaces are able to be formed by bevels or undercuts. In at least one embodiment of the present disclosure, the reinforcing element is able to be inserted into the recess in the manner of a dovetail joint.

In at least one embodiment of the present disclosure, the reinforcing element extends over the length of a longitudinal side of an elongated hole. The reinforcing element has a length corresponding to 80% to 100% of the length of the longitudinal side of the elongated hole.

In the vertical direction (z-axis) of the control arm, the reinforcing element is arranged on the upper longitudinal side of the two longitudinal sides of the elongated hole running parallel to each other.

In at least one embodiment of the present disclosure, the control arm body has at least one eccentric stop formed in the side wall at a distance from the elongated hole.

In at least one embodiment of the present disclosure, an eccentric stop is provided on both sides of the narrow side of the elongated hole. The eccentric stop(s) are made of the same material and formed integrally from the side wall. The shape is formed outwards.

The eccentric stops are able to be formed from the side wall by means of a stamp or forming tool, for example, by linear advance of a stamp. The eccentric stops are able to be shaped in such a way that they have inner stop surfaces facing the elongated hole, which extend at an angle of 20° to 80°, or 30° to 60° relative to the surface of the side wall.

The eccentric stops are able to be formed by cold forging, forming, or stamping.

The eccentric stop or the eccentric stops are formed by a deformation in the side wall, wherein the deformation has a support surface for an eccentric disc of the eccentric adjustment device and the support surface is aligned transversely to the longitudinal axis of the elongated hole. In at least one embodiment of the present disclosure, a deformation is provided adjacent to the two narrow sides of the elongated hole at a distance from the elongated hole, wherein the support surfaces of the deformations extend orthogonally to the longitudinal axis of the elongated hole.

In at least one embodiment of the present disclosure, the reinforcing element has a surface coating. A zinc or zinc flake coating is suitable. Of course, other suitable coating materials are also possible. The coating materials also have a higher hardness than the material of the control arm body or the side wall of the control arm body or the bolt or screw of an eccentric adjustment device.

### BRIEF DESCRIPTION OF THE DRAWINGS

The present disclosure is described in more detail hereinafter by means of exemplary embodiments illustrated in the drawings. In the figures:

FIG. 1 shows a control arm according to at least one embodiment of the present disclosure in a perspective view;

FIG. 2 shows a view of the control arm according to the representation in FIG. 1 in a view from the front according to at least one embodiment of the present disclosure;

FIG. 3 shows a section of a side wall of the control arm according to at least one embodiment of the present disclosure;

FIG. 4 shows a section of a side wall of a control arm body in a view of the outside of the side wall in the region of a elongated hole according to at least one embodiment of the present disclosure; and

FIG. 5 shows the section corresponding to the representation in FIG. 4 with a view of the inside of the side wall according to at least one embodiment of the present disclosure.

### DETAILED DESCRIPTION

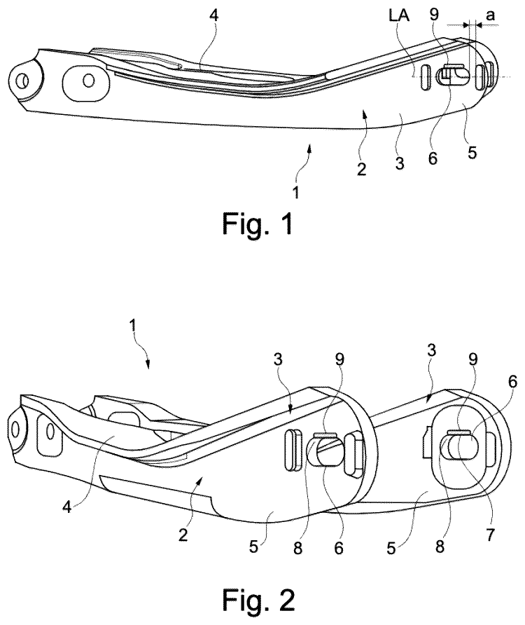

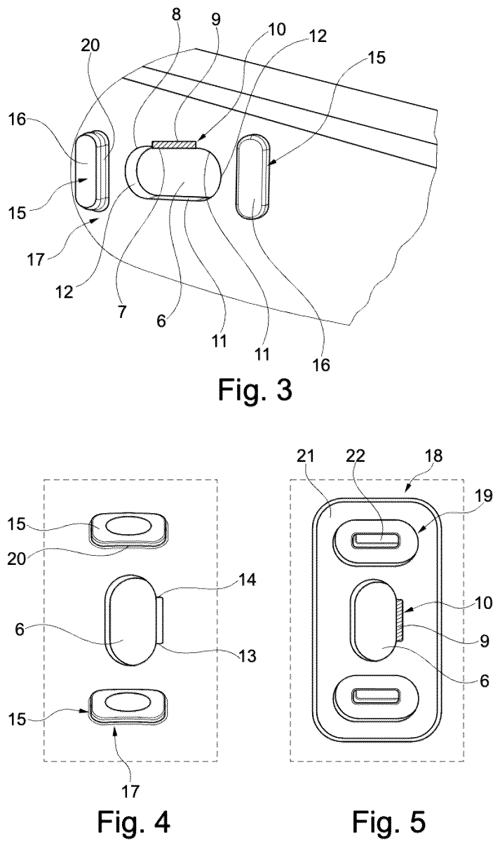

FIGS. 1 and 2 show a control arm 1 for a wheel suspension in a motor vehicle. FIG. 3 shows a section of the control arm 1.

The control arm 1 has a control arm body 2 made of a light metal material, for example, aluminum or an aluminum alloy of the 5000 series to 7000 series. The control arm body 2 has two parallel side walls 3 which are connected to each other by an upper supporting wall 4.

An elongated hole 6 is provided in each of the wheel carrier-side bearing sections 5 of a side wall 3. Each elongated hole 6 extends with its longitudinal axis LA in the longitudinal direction of the side wall 3 of the control arm body 2. The elongated holes 6 in the side walls 3 are opposite one another and are arranged coaxially to one another. The elongated holes 6 have a width that corresponds to the diameter of a bolt (eccentric bolt) guided through an elongated hole 6 plus a clearance. The length of an elongated hole 6 is a multiple of the width of the elongated hole 6 or the diameter of an eccentric bolt guided through the elongated hole 6. The elongated holes 6 in the side walls 3 are configured and intended to cooperate with an eccentric adjustment device. An eccentric adjustment device includes actuating elements having cylindrical connecting elements such as screws or bolts which are guided through the elongated holes 6. By means of the eccentric adjustment device, the arrangement and position of the wheel carrier-side bearing sections 5 of the side wall 2 and thus of the control arm body 2 is able to be adjusted relative to a wheel carrier.

Each wall section 7 of an inner wall 8 of an elongated hole 6 is formed by a reinforcing element 9. The reinforcing element 9 includes a material that has a higher hardness than the material of the side wall 3 of the control arm body 2. The material of the reinforcing element 9 also has a higher strength, for example, a higher tensile strength, than the material of the control arm body 2 and the side walls 3 forming part of the control arm body 2.

The reinforcing element 9 includes a metallic material, for example, steel.

The material from which the reinforcing element 9 is made furthermore has a higher strength, for example, a higher tensile strength, than the light metal material of the control arm body 2 and the side walls 3. The reinforcing element 9 also has at least the same strength, for example, a higher strength, than a screw or bolt of an eccentric adjustment device which interacts with the elongated hole 6.

A reinforcing element 9 is respectively arranged in a recess 10 adjacent to the elongated hole 6 in a side wall 3 of the control arm body 2. The recess 10 extends parallel to the longitudinal axis LA of an elongated hole 6 over the length of a longitudinal side 11 of the elongated hole 6. The recess 10 is open towards the elongated hole 6. The elongated hole 6 is designed as an insert which is pressed into the recess 10 and press-fitted. A reinforcing element 9 has a length which corresponds to the length of the longitudinal side 11 of the elongated hole 6. The length of the reinforcing element 9 is greater than its thickness measured in the vertical direction of the side wall 3 and greater than the width measured transversely thereto.

The recess 10 extends through a side wall 3 over its entire width. The reinforcing element 9 is arranged in the vertical direction of the control arm 1 relative to the z-axis on the upper longitudinal side 11 of the two longitudinal sides 11 of the elongated hole 6 running parallel to one another. The longitudinal sides 11 each merge into one another via semicircular narrow sides 12.

In at least one embodiment of the present disclosure, the reinforcing element 9 has a surface coating, for example, a zinc or zinc flake coating.

Form-fitting surfaces 13 are formed on the reinforcing element 9, which interact with contact surfaces 14 of the recess 10 that are configured in opposite directions (see FIG. 4 and FIG. 5). Form-fitting surfaces 13 and contact surfaces 14 are able to be formed by undercuts or dovetail-like bevels.

An eccentric stop 15 is formed in the longitudinal direction of the elongated hole 6 at a distance a adjacent to the elongated hole 6. An eccentric stop 15 is formed in one piece from a uniform material by a deformation 16 in a side wall 3. Towards the outer side 17 of a side wall 3, the deformation is raised and protrudes therefrom. On the inner side 18 of a side wall 3, the deformation 16 has an indentation 19 (see also FIG. 4 and FIG. 5). Each deformation 16 has a support surface 20 for an eccentric disc of an eccentric adjustment device, not shown here. The support surface 20 is aligned transversely, for example, orthogonally, to the longitudinal axis LA of a elongated hole 6.

For example, in FIG. 5 the indentation 19 is configured in a bowl-shaped manner. The indentation 19 has two shell regions 21, 22 of different depths. Here, the middle bottom shell section 22 is deeper than the outer shell section 21 surrounding the middle shell section 22.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-9. (canceled)

10. A control arm for a wheel suspension in a motor vehicle, the control arm comprising:
a control arm body having two side walls; and
an elongated hole in at least one side wall of the two side walls, the elongated hole configured to receive an eccentric adjusting device,
wherein at least one wall section of an inner wall of the elongated hole is configured by a reinforcing element, the reinforcing element including a material with higher hardness than a material of the at least one side wall, and
the reinforcing element is arranged in a recess in the at least one side wall adjacent to the elongated hole.

11. The control arm according to claim 10, wherein the reinforcing element is press-fitted in the recess.

12. The control arm according to claim 10, wherein the reinforcing element extends along at least 80% of a length of a longitudinal side of the elongated hole.

13. The control arm according to claim 10, wherein the reinforcing element has a plurality of form-fitting surfaces which interface correspondingly with a plurality of contact surfaces of the recess.

14. The control arm according to claim 10, further comprising at least one eccentric stop in the at least one side wall at a distance from the elongated hole.

15. The control arm according to claim 14, wherein the at least one eccentric stop comprises a deformation in the at least one side wall, the deformation includes a support surface for an eccentric disc of the eccentric adjusting device, and the support surface is aligned transversely to a longitudinal axis of the elongated hole.

16. The control arm according to claim 10, wherein the control arm body comprises aluminum or an aluminum alloy.

17. The control arm according to claim 10, wherein the reinforcing element comprises steel.

18. The control arm according to claim 10, wherein the reinforcing element comprises a surface coating.

19. The control arm according to claim 18, wherein the surface coating comprises zinc.

20. The control arm according to claim 18, wherein the surface coating comprises zinc flake coating.
